(19) United States
(12) Patent Application Publication
(10) Pub. No.: US 2026/0311099 A1
(43) Pub. Date: Oct. 8, 2026

(54) COOPERATIVE WORK MANAGEMENT APPARATUS, METHOD, AND PROGRAM

(71) Applicant: KAWASAKI JUKOGYO KABUSHIKI KAISHA, Kobe-shi, Hyogo (JP)

(72) Inventor: Hiroshi MORI, Tokyo (JP)

(73) Assignee: KAWASAKI JUKOGYO KABUSHIKI KAISHA, Kobe-shi, Hyogo (JP)

(21) Appl. No.: 19/485,132

(22) PCT Filed: May 17, 2024
(86) PCT No.: PCT/JP2024/018320

§ 371 Date: Nov. 17, 2025

(30) Foreign Application Priority Data
May 19, 2023 (JP) 2023-082774

(51) Int. Cl. G06Q 10/0639

(52) U.S. Cl. CPC G06Q 10/06393; G06Q 10/06398

(57) ABSTRACT

A cooperative work management apparatus includes processing circuitry. The processing circuitry is configured to: acquire data indicating at least one of information regarding perception, determination, or instruction of a worker or information regarding operation of a working robot; calculate features based on the acquired data; calculate an evaluation value with respect to a work result of the working robot; and calculate contribution rates of the features with respect to the evaluation value.

### TECHNICAL FIELD

The present disclosure relates to a cooperative work management apparatus, method, and program.

### BACKGROUND ART

PTL 1 discloses a performance measuring device that objectively and quantitatively measures human abilities to process tasks. This device analyzes sensing data acquired by measuring the activity of a human who is executing a task, and calculates performance indexes indicating the degrees of performance with respect to respective elemental works achieved by the above activity.

### CITATION LIST

### Patent Literature

PTL 1: Japanese Laid-Open Patent Application Publication No. 2020-35331

### SUMMARY OF INVENTION

### Technical Problem

According to the above device, when the performance of the human is poor, a factor for accurately improving the performance cannot be recognized, and the human simply has to be replaced by another human who can achieve good performance. Especially, a method that can effectively improve the performance when a human and a working robot perform work in cooperation with each other is desired.

An object of one aspect of the present disclosure is to be able to efficiently support the improvement of evaluation of a work result in cooperative work performed by a human and a working robot.

### Solution to Problem

A cooperative work management apparatus according to one aspect of the present disclosure is an apparatus that manages a cooperative work system, the cooperative work system including a working robot and a remote-control terminal, the remote-control terminal being connected to the working robot through a communication network and operated by a worker, the cooperative work management apparatus including processing circuitry configured to: acquire data indicating at least one of information regarding perception, determination, or instruction of the worker or information regarding operation of the working robot; calculate features based on the acquired data; calculate an evaluation value with respect to a work result of the working robot; and calculate contribution rates of the features with respect to the evaluation value.

A cooperative work management method according to one aspect of the present disclosure is a method of managing a cooperative work system including a working robot and a remote-control terminal, the remote-control terminal being connected to the working robot through a communication network and operated by a worker, the cooperative work management method including: acquiring data indicating at least one of information regarding perception, determination, or instruction of the worker or information regarding operation of the working robot; calculating features based on the acquired data; calculating an evaluation value with respect to a work result of the working robot; and calculating contribution rates of the features with respect to the evaluation value.

A cooperative work management program according to one aspect of the present disclosure causes at least one processor to execute the above cooperative work management method. The program may be stored in a computer-readable storage medium. The storage medium is a non-transitory, tangible medium. The storage medium may be incorporated in or externally attached to a computer (such as a mobile information terminal, a personal computer, or a server). The storage medium may include a RAM, a ROM, an EEPROM, a storage, and the like and may be, for example, a hard disk, a flash memory, an optical disk, or the like. The program stored in the storage medium may be executed by a computer to which the storage medium is directly connected, or may be executed by a computer which is connected to the storage medium through a network, such as the Internet.

### Advantageous Effects of Invention

According to one aspect of the present disclosure, the feature having a high contribution rate with respect to the evaluation value (for example, the work time) of the work result of the working robot can be recognized. By improving the ability of the worker regarding this feature, the evaluation value of the work result can be accurately improved. Therefore, in the cooperative work performed by a human and a working robot, the improvement of the evaluation of the work result can be efficiently supported.

### BRIEF DESCRIPTION OF DRAWINGS

FIG. 1 is an overall view of a cooperative work system including a cooperative work management apparatus according to an embodiment.

FIG. 2 is a conceptual diagram that explains a task execution process performed by a worker and a working robot in the cooperative work system shown in FIG. 1.

FIG. 3 is a block diagram of the working robot shown in FIG. 1.

FIG. 4 is a block diagram of a remote-control terminal shown in FIG. 1.

FIG. 5 is a block diagram of a cooperative work management server shown in FIG. 1.

FIG. 6 is a diagram showing an example of a display screen image of a display of the remote-control terminal shown in FIG. 4.

FIG. 7 is a diagram that explains elemental works performed by the working robot and the worker shown in FIG. 1.

FIG. 8 is a flowchart that explains processing performed by the cooperative work management server shown in FIG. 5.

FIG. 9 is a block diagram that explains principal component analysis performed by the cooperative work management server shown in FIG. 5.

FIG. 10 is a diagram that explains a gaze plot obtained by tracking the gaze of the worker.

FIG. 11 is a block diagram that explains ability analysis performed by the cooperative work management server shown in FIG. 5.

### DESCRIPTION OF EMBODIMENTS

Hereinafter, an embodiment will be described with reference to the drawings.

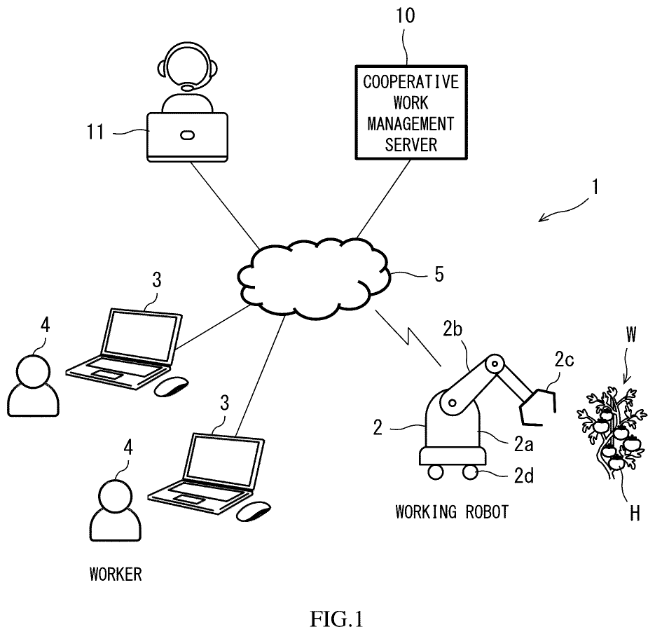

FIG. 1 is an overall view of a cooperative work system 1 including a cooperative work management server 10 according to the embodiment. As shown in FIG. 1, the cooperative work system 1 includes: a working robot 2; a remote-control terminal 3 that is communicable with the remote-control terminal 3 through a communication network 5; and the cooperative work management server 10 that is communicable with the working robot 2 and the remote-control terminal 3 through the communication network 5. The communication network 5 is, for example, the Internet but may be an intranet or the like.

In the present embodiment, as the working robot 2, a working robot that performs harvesting work of a harvesting target H (such as a fruit or a vegetable) of a plant that is a work target W is exemplified. However, it is sufficient that the working robot 2 performs some kind of work. The working robot 2 may perform another type of work (such as visual inspection or part selection and collection).

The working robot 2 includes: a body 2a; an articulated arm 2b projecting from the body 2a; an end effector 2c located at a tip of the articulated arm 2b; and a wheel 2d supporting the body 2a. As one example, the end effector 2c is a robot hand that can hold an object. The working robot 2 may be detachably equipped with a basket that collects the object held by the robot hand. As described below, the working robot 2 is equipped with a sensor, a controller, an actuator, and an interface. The working robot 2 is not limited to a robot that moves by traveling on the ground and may be, for example, a drone that moves by flying in the air.

The remote-control terminal 3 is operated by a worker 4 who is a human. To be specific, the worker 4 operates the remote-control terminal 3 to remotely control the working robot 2 that is connected to the remote-control terminal 3 through the communication network 5. The cooperative work management server 10 receives data of the working robot 2 and data of the remote-control terminal 3 through the communication network 5. The cooperative work system 1 may include a management terminal 11 that is communicable with the cooperative work management server 10 through the communication network 5.

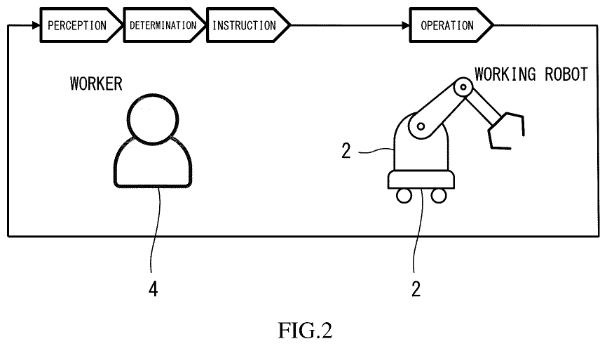

FIG. 2 is a conceptual diagram that explains a task execution process performed by the worker 4 and the working robot 2 in the cooperative work system 1 shown in FIG. 1. As shown in FIG. 2, in the cooperative work system 1, task components constituting a task are shared between the working robot 2 and the worker 4. Specifically, one task is constituted by respective task components that are “perception,” “determination,” “instruction,” and “operation.” The “perception” is performed based on information after the immediately preceding “operation.” The “determination” is performed based on information of the “perception.” The “instruction” is performed based on information of the “determination.” The “operation” is performed based on information of the “instruction.” In the cooperative work system 1, the working robot 2 and the worker 4 cooperatively performs work. Therefore, the task components “perception,” “determination,” and “instruction” are performed by the worker 4, and the task component “operation” is performed by the working robot 2.

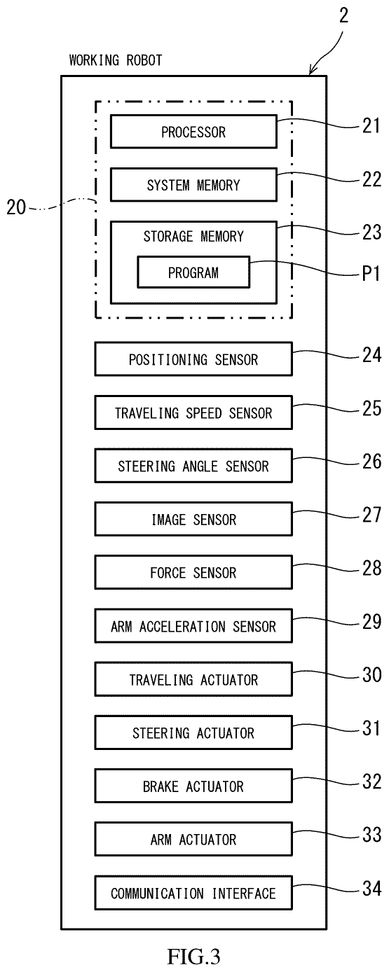

FIG. 3 is a block diagram of the working robot 2 shown in FIG. 1. As shown in FIG. 3, the working robot 2 includes processing circuitry 20, a positioning sensor 24, a traveling speed sensor 25, a steering angle sensor 26, an image sensor 27, a force sensor 28, an arm acceleration sensor 29, a traveling actuator 30, a steering actuator 31, a brake actuator 32, an arm actuator 33, and a communication interface 34.

The processing circuitry 20 includes a processor 21, a system memory 22, and a storage memory 23. The processor 21 may include a CPU (central processing unit). The system memory 22 may include a RAM. The storage memory 23 may include a hard disk, a flash memory, or a combination thereof. The storage memory 23 stores a program P1. A configuration in which the processor 21 executes the program P1 read from the storage memory 23 into the system memory 22 is one example of the processing circuitry of the working robot 2.

The positioning sensor 24 detects the position of the working robot 2 and may be, for example, a satellite positioning sensor, such as a GPS sensor. However, the positioning sensor 24 is not limited to the satellite positioning sensor. For example, the position of the working robot 2 on map information may be specified in such a manner that a distance sensor measures distances of surroundings of the working robot 2, and the acquired shapes of the surroundings of the working robot 2 are matched with the shapes in the map information. To be specific, the positioning sensor 24 may be realized by a combination of the distance sensor and software that matches the shapes detected by the distance sensor with the map information. The distance sensor is a sensor that detects position data of outer surfaces of obstacles by emitting light, radio waves, or ultrasonic waves toward the surroundings of the working robot 2 and receiving reflected waves. For example, the distance sensor may be a LIDAR (Light Detection and Ranging) sensor, a millimeter wave radar, or a depth sensing camera. Or, the positioning sensor 24 may acquire position coordinates by wireless communication with locators on land using radio waves, sound waves, light, or magnetism. As a positioning principle using the locators, for example, an AOA (Angle Of Arrival) method, a RSSI (Received Signal Strength Indicator) method, a TOA (Time of Arrival) method, or a TDOA (Time Difference Of Arrival) method may be used.

The traveling speed sensor 25 detects a traveling speed of the working robot 2. For example, the traveling speed sensor 25 detects the rotational speed of the wheel 2d of the working robot 2. The steering angle sensor 26 detects the steering angle of the wheel 2d. The image sensor 27 can acquire an image of the work target W located close to the working robot 2 and may be, for example, a camera. The force sensor 28 detects the magnitude and direction of force or moment and is located at the articulated arm 2b or the end effector 2c. The arm acceleration sensor 29 detects the acceleration of the operation of the articulated arm 2b. The sensors mounted on the working robot 2 are not especially limited, and may include, for example, a gyro sensor, a distance sensor, and the like.

The traveling actuator 30 drives the wheel 2d and is, for example, an electric motor. The steering actuator 31 drives a steering structure that steers the wheel 2d, and is, for example, an electric motor. The brake actuator 32 drives a brake that brakes the wheel 2d, and is, for example, an electric motor. The arm actuator 33 drives the articulated arm 2b or the end effector 2c and is, for example, an electric motor. The communication interface 34 includes a communicator that is connected to the communication network 5 through wired or wireless connection.

In the working robot 2, the processor 21 that executes the program P1 read from the storage memory 23 into the system memory 22 controls at least one of the actuators 30 to 33 based on information input from at least one of the sensors 24 to 29.

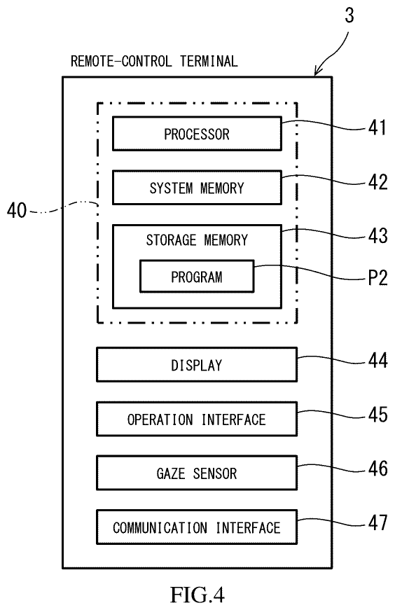

FIG. 4 is a block diagram of the remote-control terminal 3 shown in FIG. 1. As shown in FIG. 4, the remote-control terminal 3 includes processing circuitry 40, a display 44, an operation interface 45, a gaze sensor 46, and a communication interface 47. The processing circuitry 40 includes a processor 41, a system memory 42, and a storage memory 43. The processor 41 is, for example, a CPU. The system memory 42 is, for example, a RAM. The storage memory 43 is an example of a computer-readable medium and is a non-transitory, tangible medium. The storage memory 43 may include a ROM. The storage memory 43 may include a hard disk, a flash memory, or a combination thereof. The storage memory 43 stores a program P2. A configuration in which the processor 41 executes the program P2 read into the system memory 42 is one example of the processing circuitry of the remote-control terminal 3.

The display 44 is not especially limited as long as it can output an image to the worker 4. Examples of the display 44 may include a liquid crystal display, an organic EL display, a head mount display, and a VR display. The operation interface 45 is a user interface operated by the worker 4. The operation interface 45 includes at least one selected from, for example, a keyboard, a mouse, a touch panel, a lever, a handle, and the like.

The gaze sensor 46 may be, for example, a combination of a camera that takes images of the movements of the eyes of the worker 4 and software that subjects the images taken by the camera to image processing to analyze the movements of the eyes. However, the gaze sensor 46 may use a different type of gaze detection technology. The communication interface 47 includes a communicator that is connected to the communication network 5 through wired or wireless connection.

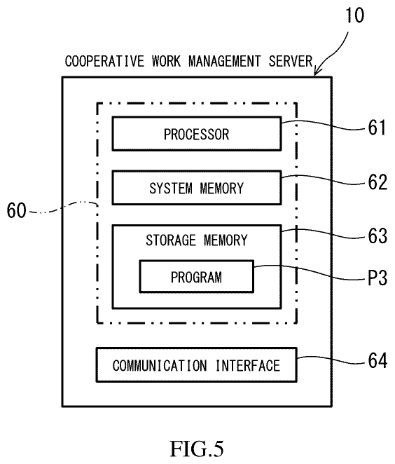

FIG. 5 is a block diagram of the cooperative work management server 10 shown in FIG. 1. As shown in FIG. 5, the cooperative work management server 10 includes processing circuitry 60 and a communication interface 64. The processing circuitry 60 includes a processor 61, a system memory 62, and a storage memory 63. The communication interface 64 includes a communicator that is connected to the communication network 5 through wired or wireless connection. The processor 61 may include a CPU (central processing unit). The system memory 62 may include a RAM. The storage memory 63 may include a hard disk, a flash memory, or a combination thereof. The storage memory 63 stores a cooperative work management program P3. A configuration in which the processor 61 executes the cooperative work management program P3 read from the storage memory 63 into the system memory 62 is one example of the processing circuitry of the cooperative work management server 10.

The cooperative work management server 10 collects data from the working robot 2 and the remote-control terminal 3 and stores the data in the storage memory 63. The program P3 stores a below-described principal component analysis model 71 and a below-described ability analysis model 72.

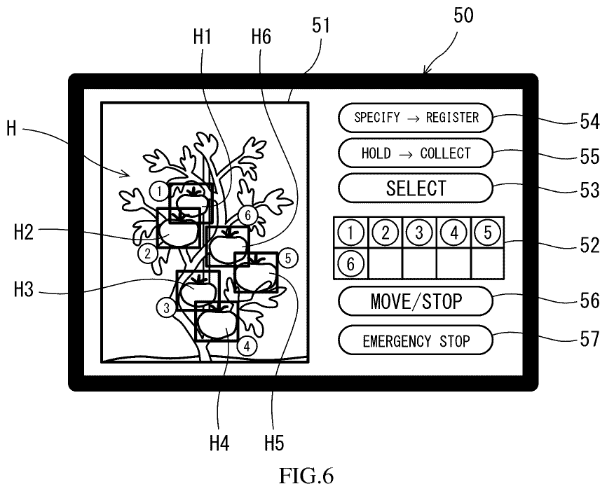

FIG. 6 is a diagram showing an example of a display screen image 50 of the display 44 of the remote-control terminal 3 shown in FIG. 4. The below-described control of the display screen image 50 is executed in such a manner that the processor 41 of the remote-control terminal 3 operates in accordance with the program P2. As shown in FIG. 6, the display screen image 50 displays a harvesting display region 51, a selection display region 52, a select icon 53, a specify-register icon 54, a hold-collect icon 55, a move-stop icon 56, and an emergency stop icon 57.

The processing circuitry 40 of the remote-control terminal 3 receives the image, obtained by the image sensor 27 of the working robot 2 which takes the image of the work target W, through the communication network 5 in real time. The processing circuitry 40 displays the received image in the harvesting display region 51. Harvesting targets H1 to H6 may include both a ripe target suitable for harvesting and an unripe target unsuitable for harvesting. To improve the ease of identification of the harvesting targets H1 to H6 in the harvesting display region 51, the processing circuitry 40 may emphasize the harvesting targets H1 to H6 by, for example, displaying frames surrounding the harvesting targets H1 to H6.

When the worker 4 uses the operation interface 45 to specify (click with a mouse or tap, for example) the harvesting targets H1 to H6 on the screen image of the harvesting display region 51, the processing circuitry 40 performs clustering using a known image processing technology to recognize the regions of the specified harvesting targets on the image, and displays the contours of the recognized regions on the screen image. In this state, when the worker 4 selects the specify-register icon 54, the processing circuitry 40 adds images (in FIG. 6, the numbers of the harvesting targets H1 to H6) indicating the specified harvesting targets to the selection display region 52.

When the worker 4 uses the operation interface 45 to select any one of the harvesting targets H1 to H6 in the selection display region 52 and select the select icon 53, the processing circuitry 40 emphasizes (for example, changes the color of) the number selected by the select icon 52. In this state, when the worker 4 uses the operation interface 45 to select the hold-collect icon 55, the processing circuitry 40 transmits an instruction to the working robot 2 through the communication network 5 such that the working robot 2 holds and collects the harvesting target selected by the select icon 53. In the selection display region 52, the processing circuitry 40 grays out the image indicting the harvesting target which has already been instructed by the hold-collect icon 55.

When the worker 4 uses the operation interface 45 to select the move-stop icon 56 while the working robot 2 is in a stop state, the processing circuitry 40 transmits an instruction to the working robot 2 through the communication network 5 such that the working robot 2 moves to the next work target W. When the worker 4 uses the operation interface 45 to select the move-stop icon 56 while the working robot 2 is moving, the processing circuitry 40 transmits an instruction to the working robot 2 through the communication network 5 such that the working robot 2 stops moving and becomes a stop state. When the worker 4 uses the operation interface 45 to select the emergency stop icon 57, the processing circuitry 40 transmits an instruction to the working robot 2 through the communication network 5 such that the working robot 2 stops unconditionally.

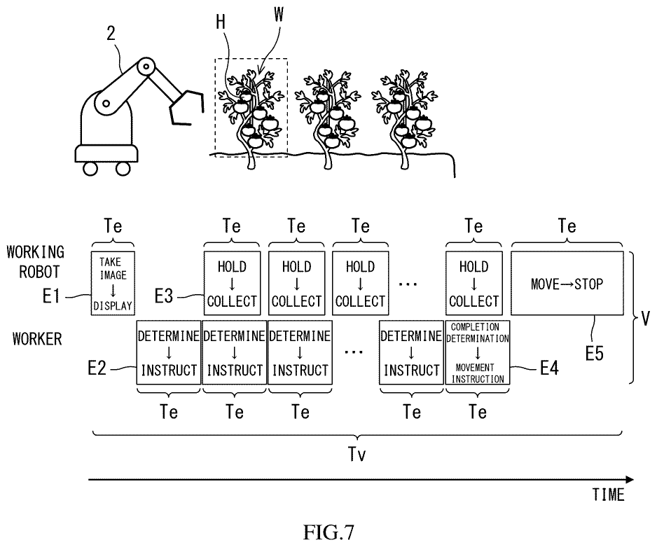

FIG. 7 is a diagram that explains elemental works E1 to E5 performed by the working robot 2 and the worker 4 shown in FIG. 1. As shown in FIG. 7, work with respect to one work target W (one plant, for example) is divided into work performed by the working robot 2 and work performed by the worker 4. The entire work with respect to one work target W (one plant, for example) is called a unit work V. The unit work V includes: the elemental works E1, E3, and E5 performed by the working robot 2; and the elemental works E2 and E4 performed by the worker 4.

Specifically, first, the working robot 2 takes the image of the work target W (one plant, for example) by the image sensor 27 and transmits the taken image to the remote-control terminal 3, and the remote-control terminal 3 displays the received image on the display 44. This elemental work E1 is referred to as an “take image-display” elemental work.

Next, the worker 4 sees the image (harvesting display region 51 in FIG. 6) displayed on the display 44 of the remote-control terminal 3 and determines which of the harvesting targets H1 to H6 (FIG. 6) to harvest. Then, the worker 4 operates the icons 53 to 55 of the display screen image 50 (FIG. 6) to transmit an instruction to the working robot 2 such that the working robot 2 collects the selected harvesting target. This elemental work E2 is referred to as a “determine-instruct” elemental work.

Next, upon receiving the instruction, the processing circuitry 20 of the working robot 2 drives the arm actuator 33 to hold the selected harvesting target and collect the harvesting target in the basket mounted on the working robot 2. This elemental work E3 is referred to as a “hold-collect” elemental work. After that, the “determine-instruct” elemental work and the “hold-collect” elemental work are alternately repeated.

Next, when the worker 4 sees the image (harvesting display region 51 in FIG. 6) displayed on the display 44 of the remote-control terminal 3 and determines that the harvesting work for the work target W has been completed, the worker 4 selects the move-stop icon 56 of the display screen image 50 to transmit an instruction to the working robot 2 such that the working robot 2 moves to the next work target W (for example, the adjacent plant). This elemental work E4 is referred to as a “completion determination-movement instruction” elemental work.

Next, upon receiving the instruction, the processing circuitry 20 of the working robot 2 drives the traveling actuator 30 and the like, and thus, the working robot 2 moves to the next work target W (for example, the adjacent plant). When the working robot 2 reaches a position suitable for the work with respect to the next work target W, the working robot 2 stops. This elemental work E5 is referred to as a “move-stop” elemental work. This set of the elemental works including the “take image-display” elemental work E1 to the “move-stop” elemental work E5 is called the unit work V.

A work time required to perform the unit work V is called a unit work time Tv. A work time required to perform each of the elemental works E1 to E5 is called an elemental work time Te. Although the reference sign Te is attached to each of the elemental work times, the elemental work times may be actually different from each other. The elemental work times Te and the unit work time Tv are measured by the cooperative work management server 10.

Regarding the elemental work time Te of the “take image-display” elemental work E1, the processing circuitry 20 of the working robot 2 transmits to the cooperative work management server 10 a time t1 at which the instruction of the image-taking is transmitted to the image sensor 27, and the processing circuitry 40 of the remote-control terminal 3 transmits to the cooperative work management server 10 a time t2 at which the image taken by the image sensor 27 is displayed on the display 44. The processing circuitry 60 of the cooperative work management server 10 acquires the time t1 and the time t2 from the working robot 2 and the remote-control terminal 3 through the communication network 5 and calculates a difference (t2−t1) between these times as the elemental work time Te of the “take image-display” elemental work E1.

Regarding the elemental work time Te of the “deterministic-instruct” elemental work E2, the remote-control terminal 3 transmits to the cooperative work management server 10 the time t2 at which the image taken by the image sensor 27 is displayed on the display 44 and a time t3 at which the worker 4 operates the operation interface 45 of the remote-control terminal 3 to select the hold-collect icon 55 of the display screen image 50. The processing circuitry 60 of the cooperative work management server 10 acquires the time 2 and the time t3 from the remote-control terminal 3 through the communication network 5 and calculates a difference (t3−t2) between these times as the elemental work time Te of the “determine-instruct” elemental work E2.

Regarding the elemental work time Te of the “hold-collect” elemental work E3, the processing circuitry 20 of the working robot 2 transmits to the cooperative work management server 10 a time t4 at which the processing circuitry 20 starts driving the arm actuator 33 upon receiving the instruction of the holding and the collecting and a time t5 at which it is determined based on the operation of the articulated arm 2b that the harvesting target H has been held and collected in the basket. The processing circuitry 60 of the cooperative work management server 10 acquires the time t4 and the time t5 from the working robot 2 through the communication network 5 and calculates a difference (t5−t4) between these times as the elemental work time Te of the “hold-collect” elemental work E3.

Regarding the elemental work time Te of the “completion determination-movement instruction” elemental work E4, the processing circuitry 20 of the working robot 2 transmits to the cooperative work management server 10 a time t6 at which it is determined that the last harvesting target H has been held and collected in the basket, and the processing circuitry 40 of the remote-control terminal 3 transmits to the cooperative work management server 10 a time t7 at which the worker 4 operates the operation interface 45 of the remote-control terminal 3 to select the move-stop icon 56 of the display screen image 50 such that the working robot 2 moves to the next work target W. The processing circuitry 60 of the cooperative work management server 10 acquires the time t7 and the time t6 from the working robot 2 and the remote-control terminal 3 through the communication network 5 and calculates a difference (t7−t6) between these times as the elemental work time Te of the “completion determination-movement instruction” elemental work E4.

Regarding the elemental work time Te of the “move-stop” elemental work E5, the processing circuitry 20 of the working robot 2 transmits to the cooperative work management server 10 a time t8 at which the working robot 2 starts moving to the next work target W and a time t9 at which the working robot 2 has reached the next work target W and stopped. The processing circuitry 60 of the cooperative work management server 10 acquires the time t8 and the time t9 from the working robot 2 through the communication network 5 and calculates a difference (t9−t8) between these times as the elemental work time Te of the “move-stop” elemental work E5.

The processing circuitry 60 of the cooperative work management server 10 calculates as the unit work time Tv a time from a start time of the “take image-display” elemental work E1 that is the first elemental work of the unit work V to an end time of the “move-stop” elemental work E5 that is the last elemental work of the unit work V.

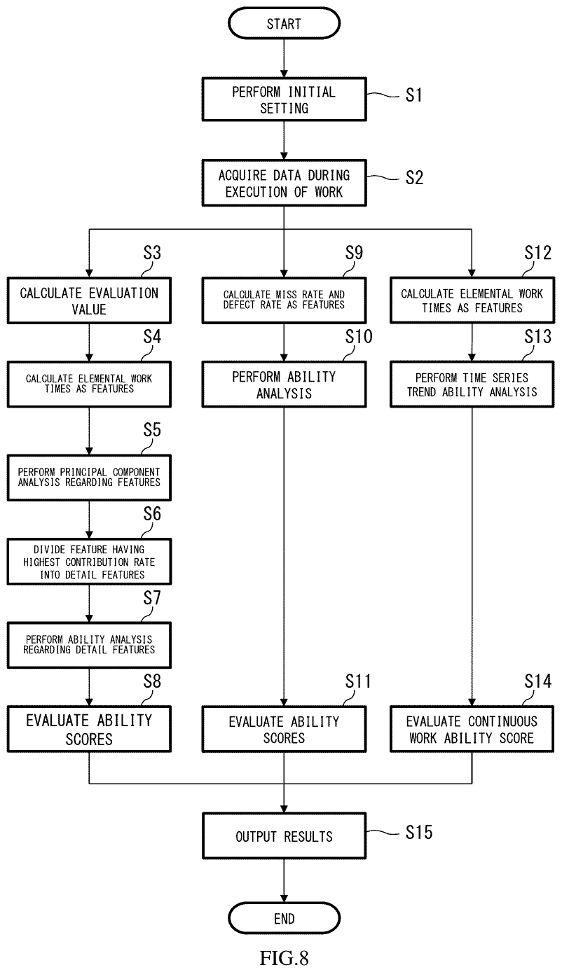

FIG. 8 is a flowchart that explains processing performed by the cooperative work management server 10 shown in FIG. 5. Hereinafter, the flow in FIG. 8 will be described with suitable reference to the drawings other than FIG. 8. In the following description, the processing of the cooperative work management server 10 is executed by the processing circuitry 60.

In the cooperative work management server 10, an operator operates the management terminal 11 to perform initial setting for managing cooperative work performed by the working robot 2 and the remote-control terminal 3 (Step S1). When the worker 4 operates the remote-control terminal 3 to start the work of the working robot 2, the cooperative work management server 10 acquires data from the working robot 2 and the remote-control terminal 3 (Step S2). The acquired data is referred to as collection data.

The collection data may include: data detected by the sensors included in the working robot 2 and the remote-control terminal 3; data indicating times (such as a start time and an end time) at which the working robot 2 has performed specific operation or processing; and data indicating times (such as an operation time, a start time, and an end time) at which the remote-control terminal 3 has performed specific operation, processing, or the like. The data collected by the cooperative work management server 10 from the remote-control terminal 3 indicates information regarding the perception, determination, or instruction of the worker 4. The data collected by the cooperative work management server 10 from the working robot 2 indicates information regarding the operation of the working robot 2.

The cooperative work management server 10 calculates from the collection data an evaluation value with respect to a work result of the working robot (Step S3). For example, as the evaluation value, the cooperative work management server 10 calculates the unit work time Tv from the collection data. When the unit work time Tv is short, the evaluation is high. When the unit work time Tv is long, the evaluation is low.

The cooperative work management server 10 calculates, as features, the elemental work times Te of the elemental works E1 to E5 from the collection data (Step S4). Then, the cooperative work management server 10 performs principal component analysis that uses the calculated features (elemental work times Te) and the calculated evaluation value (unit work time Tv) as inputs (Step S5).

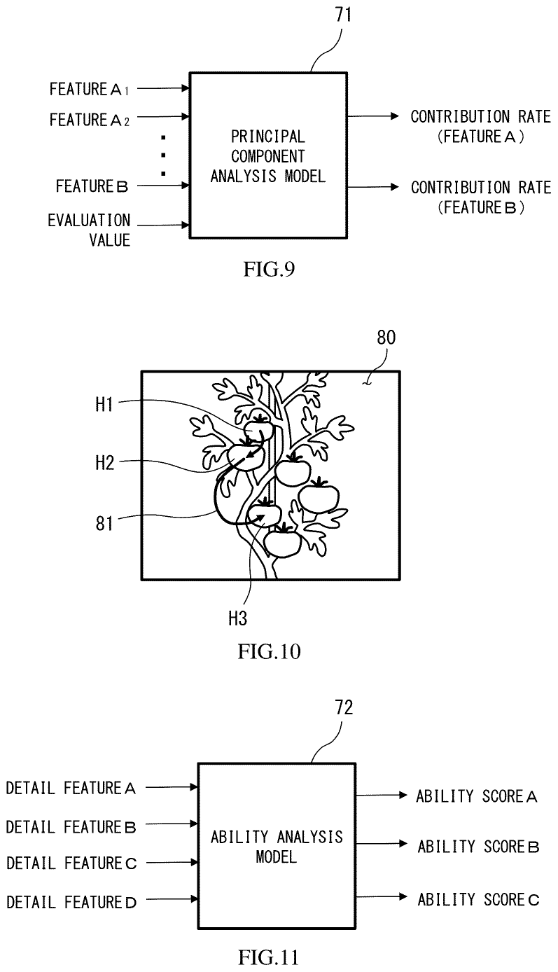

FIG. 9 is a block diagram that explains the principal component analysis performed by the cooperative work management server 10 shown in FIG. 5. As shown in FIG. 9, the cooperative work management server 10 includes the principal component analysis model 71. The principal component analysis model 71 is a machine learning model using a known principal component analysis technology. When the features are input to the principal component analysis model 71 together with the evaluation value, the principal component analysis model 71 outputs contribution rates of the respective features with respect to the change in the evaluation value.

When performing the principal component analysis regarding the work of the worker 4 (Step S5), for example, the elemental work times Te of the “determine-instruct” elemental works E2 in the unit work V and the elemental work time Te of the “completion determination-movement instruction” elemental work E4 in the unit work V are input as the features to the principal component analysis model 71, and the unit work time Tv of the unit work V is input as the evaluation value to the principal component analysis model 71. When the unit works V are performed, the elemental work times Te and the unit work times Tv of these unit works V are similarly input to the principal component analysis model 71.

Then, the principal component analysis model 71 outputs the contribution rate of the elemental work time Te of the “determine-instruct” elemental work E2 and the contribution rate of the elemental work time Te of the “completion determination-movement instruction” elemental work E4. Herein, among all the contribution rates, the contribution rate of the elemental work time Te of the “determine-instruct” elemental work E2 is assumed to be the highest.

The cooperative work management server 10 calculates detail features obtained by dividing the feature (elemental work time Te of the “determine-instruct” elemental work E2) having the highest contribution rate (Step S6). The detail features obtained by dividing the elemental work time Te of the “determine-instruct” elemental work E2 may be, for example, an “eye point transition time,” an “eye point residence time,” and an “eye point separation time.”

FIG. 10 is a diagram that explains a gaze plot obtained by tracking the gaze of the worker 4. As shown in FIG. 10, the cooperative work management server 10 analyzes the movement of the gaze of the worker 4 during the work using a known eye tracking technology based on image data 80 of the work target W displayed in the harvesting display region 51 of the display screen image 50 of the remote-control terminal 3 and eye point trajectory data 81 indicating the trajectory of the eye point (point of regard) of the worker 4 on the image data screen image 80. The trajectory of the eye point of the worker 4 on the image data screen image 80 is calculated from the movement of the eye detected by the gaze sensor 46 of the remote-control terminal 3. The cooperative work management server 10 specifies the contours of the harvesting targets H1 to H3 included in the image data 80 by using a known image recognition technology.

The “eye point transition time” denotes a time from when the eye point indicated by the eye point trajectory data 81 on the image data 80 moves out from the contour of the harvesting target H1 selected first until the eye point gets into the contour of the harvesting target H2 selected next. The “eye point residence time” denotes a time from when the eye point indicated by the eye point trajectory data 81 on the image data 80 gets into the contour of the selected harvesting target H1, H2, or H3 until the eye point gets out from the contour. The “eye point separation time” denotes a time from when the eye point indicated by the eye point trajectory data 81 on the image data 80 gets out from the contour of the selected harvesting target H1, H2, or H3 until the eye point returns into the same contour.

FIG. 11 is a block diagram that explains ability analysis performed by the cooperative work management server 10 shown in FIG. 5. As shown in FIG. 11, the cooperative work management server 10 includes the ability analysis model 72. The ability analysis model 72 is a trained machine learning model. The cooperative work management server 10 performs the ability analysis regarding the calculated detail features by using the ability analysis model 72 (Step S7). When the calculated detail features are input to the ability analysis model 72, the ability analysis model 72 outputs one or more ability scores.

For example, the “eye point transition time,” the “eye point residence time,” and the “eye point separation time” are input as the detail features to the ability analysis model 72, and the ability analysis model 72 outputs one or more ability scores. Herein, examples of the ability scores include an “exploration ability score,” a “decision-making ability score,” and a “determination ability score.” The “exploration ability score” is a value that tends to increase as the “eye point transition time” decreases, and indicates an ability to explore the harvesting target to be harvested. The “decision-making ability score” is a value that tends to increase as the “eye point residence time” mainly decreases, and indicates a decision-making ability to specify the harvesting target and output the instruction of the collecting. The “determination ability score” is a value that tends to increase as the “eye point separation time” decreases, and indicates a determination ability to decisively determine the harvesting target to be harvested. Instead of the ability analysis model 72, a calculation formula that uses the detail features as inputs and outputs the ability scores may be used.

The cooperative work management server 10 evaluates the output ability scores by comparing the ability scores with predetermined reference scores (Step S8). Specifically, the cooperative work management server 10 evaluates the “exploration ability score,” the “decision-making ability score,” and the “determination ability score” by comparing these scores with the corresponding reference scores. Herein, that the ability score is higher than the reference score denotes that the evaluation is high, and that the ability score is lower than the reference score denotes that the evaluation is low.

When the contribution rate of the elemental work time Te of the “completion determination-movement instruction” elemental work E4 is the highest among all the contribution rates in the principal component analysis, the cooperative work management server 10 may calculate the detail features obtained by dividing the feature (elemental work time Te of the “completion determination-movement instruction” elemental work E4) having the highest contribution rate (Step S6). Examples of the detail features obtained by dividing the elemental work time Te of the “completion determination-movement instruction” elemental work E4 may include the “eye point transition time,” the “eye point residence time,” the “eye point separation time,” and a “movement instruction time.” The “movement instruction time” denotes a time from when the final collection is completed until the worker outputs an instruction that moves the working robot 2 to the next work target W. Then, the cooperative work management server 10 may perform the ability analysis regarding the calculated detail features by using the ability analysis model 72 (Step S7). When the calculated detail features are input to the ability analysis model 72, the ability analysis model 72 may output one or more ability scores, such as the “exploration ability score,” the “decision-making ability score,” and the “determination ability score.”

In Steps S3 to S8 described above, the work of the worker 4 was described. However, in Steps S3 to S8, the work of the working robot 2 may also be executed.

When performing the principal component analysis regarding the work of the working robot 2 (Step S5), the elemental work time Te of the “take image-display” elemental work E1 in the unit work V, the elemental work times Te of the “hold-collect” elemental works E3 in the unit work V, and the elemental work time Te of the “move-stop” elemental work E5 in the unit work V are input as the features to the principal component analysis model 71, and the unit work time Tv of the unit work V is input as the evaluation value to the principal component analysis model 71. The principal component analysis model regarding the work of the worker 4 and the principal component analysis model regarding the work of the working robot 2 are different in learned contents from each other but are the same in principle as each other. Therefore, the same refence sign (71) is used for simplicity.

In accordance with the above inputs, the principal component analysis model 71 outputs the contribution rate of the elemental work time Te of the “take image-display” elemental work E1, the contribution rate of the elemental work time Te of the “hold-collect” elemental work E3, and the contribution rate of the elemental work time Te of the “move-stop” elemental work E5. Herein, among all the contribution rates, the contribution rate of the elemental work time Te of the “hold-collect” elemental work E3 is assumed to be the highest.

The cooperative work management server 10 calculates the detail features obtained by dividing the feature (elemental work time Te of the “hold-collect” elemental work E3) having the highest contribution rate (Step S6). Examples of the detail features obtained by dividing the elemental work time Te of the “hold-collect” elemental work E3 include “acceleration sensor time-series data,” “gyro sensor time-series data,” and “hold-release coordinates-time data”.

The “acceleration sensor time-series data” is time-series data of operation acceleration of the articulated arm 2b of the working robot 2. The “gyro sensor time-series data” is time-series data of, for example, angular velocity of the articulated arm 2b of the working robot 2. The “hold-release coordinates-time data” is data indicating coordinates and a time at which the articulated arm 2b of the working robot 2 has held the harvesting target and coordinates and a time at which the articulated arm 2b of the working robot 2 has released the held harvesting target. The “hold-release coordinates-time data” is data indicating coordinates and a time at which the working robot 2 has held the harvesting target and coordinates and a time at which the working robot 2 has released the held harvesting target.

The cooperative work management server 10 performs the ability analysis regarding the calculated detail features by using the ability analysis model 72 (Step S7). The ability analysis model regarding the work of the worker 4 and the ability analysis model regarding the work of the working robot 2 are different in learned contents from each other but are the same in principle as each other. Therefore, the same reference sign (72) is used for simplicity.

For example, the “acceleration sensor time-series data,” the “gyro sensor time-series data,” and the “hold-release coordinates-time data” are input as the detail features to the ability analysis model 72, and the ability analysis model 72 outputs one or more ability scores. Herein, examples of the ability scores include “arm acceleration,” “arm speed,” and “arm deceleration.” Instead of the ability analysis model 72, a calculation formula that uses the detail features as inputs and outputs the ability scores may be used.

The cooperative work management server 10 evaluates the output ability scores by comparing the ability scores with predetermined reference scores (Step S8). Specifically, the cooperative work management server 10 evaluates the “arm acceleration,” the “arm speed,” and the “arm deceleration” by comparing these scores with the corresponding reference scores. Herein, that the ability score is higher than the reference score denotes that the evaluation is high, and that the ability score is lower than the reference score denotes that the evaluation is low.

The cooperative work management server 10 also executes Steps S9 to S11 in addition to Steps S3 to S8 described above. Specifically, the cooperative work management server 10 calculates a “miss rate” and a “defect rate” as the features (Step S9). The “miss rate” indicates a value obtained by dividing the number of harvesting targets which have not been collected among the harvesting targets to be harvested by the total number of harvesting targets to be harvested. The “defect rate” indicates a value obtained by dividing the number of harvesting targets which have been collected but should not be collected by the total number of harvesting targets which have been collected.

The cooperative work management server 10 performs the ability analysis in which the ability score (an identification ability score, for example) is calculated from these features (the miss rate and the defect rate, for example) (Step S10). Specifically, the cooperative work management server 10 uses a predetermined mathematical expression to calculate the identification ability score such that the identification ability score decreases as the “miss rate” increases, and also calculate the identification ability score such that the identification ability score decreases as the “defect rate” increases.

The cooperative work management server 10 evaluates the calculated ability scores by comparing the ability scores with predetermined reference scores (Step S11). Specifically, the cooperative work management server 10 evaluates the score by comparing the “identification ability score” with the reference score. Herein, that the ability score is higher than the reference score denotes that the evaluation is high, and that the ability score is lower than the reference score denotes that the evaluation is low.

The cooperative work management server 10 also executes Steps S12 to S14 in addition to Steps S3 to S8 and S9 to S11 described above. Specifically, as the features, the cooperative work management server 10 calculates the elemental work times Te of the elemental works E2 and E4 regarding the worker 4 from the collection data (Step S12). These features are calculated for each of the unit works V lined up in time series.

For example, when the first unit work V, the second unit work V, and the third unit work V are performed in this order in series, the cooperative work management server 10 calculates as the features the elemental work time Te of the “determine-instruct” elemental work E2 of the first unit work V, the elemental work time Te of the “determine-instruct” elemental work E2 of the second unit work V, and the elemental work time Te of the “determine-instruct” elemental work E2 of the third unit work. These times are elemental work times required for the respective elemental works corresponding to each other.

The cooperative work management server 10 may calculate as the features the elemental work time Te of the “completion determination-movement instruction” elemental work E4 of the first unit work V, the elemental work time Te of the “completion determination-movement instruction” elemental work E4 of the second unit work V, and the elemental work time Te of the “completion determination-movement instruction” elemental work E4 of the third unit work V.

The cooperative work management server 10 calculates a time series increasing/decreasing trend of the elemental work times Te required for the respective elemental works (“determine-instruct” elemental works E2) which constitute the first to third unit works V and correspond to each other (Step S13). For example, when the elemental work times Te required for the respective elemental works which constitute the first to third unit works V and correspond to each other show a time series increasing trend, it is thought that the concentration of the worker 4 is decreasing due to performing the first to third unit works V continuously. On the other hand, when the elemental work times Te required for the respective elemental works which constitute the first to third unit works V and correspond to each other do not show the time series increasing trend, it is thought that the concentration of the worker 4 is maintained even while performing the first to third unit works V continuously.

Specifically, the cooperative work management server 10 calculates the time series increasing/decreasing trend of the elemental work time Te of the “determine-instruct” elemental work E2 of the first unit work V, the elemental work time Te of the “determine-instruct” elemental work E2 of the second unit work V, and the elemental work time Te of the “determine-instruct” elemental work E2 of the third unit work. For example, when the elemental work time Te of the “determine-instruct” elemental work E2 of the second unit work is longer than the elemental work time Te of the “determine-instruct” elemental work E2 of the first unit work V, and the elemental work time Te of the “determine-instruct” elemental work E2 of the third unit work is longer than the elemental work time Te of the “determine-instruct” elemental work E2 of the second unit work V, a continuous work ability score of the worker 4 is reduced. On the other hand, when the changes in the elemental work times Te of the “determine-instruct” elemental works E2 of the first to third unit works V are small, the continuous work ability score of the worker 4 is increased.

The cooperative work management server 10 evaluates the output continuous work ability score by comparing the continuous work ability score with a predetermined reference score (Step S14). Herein, that the continuous work ability score is higher than the reference score denotes that the evaluation is high, and that the continuous work ability score is lower than the reference score denotes that the evaluation is low.

The cooperative work management server 10 outputs an evaluation result of the ability score in Step S8, an evaluation result of the ability score in Step S11, and an evaluation result of the continuous work ability score in Step S14 (Step S15). For example, the cooperative work management server 10 outputs the evaluation results to the management terminal 11 through the communication network 5. The operator of the management terminal 11 who saw the evaluation results can recognize which ability is most appropriate to improve in order to achieve the objective regarding the unit work time Tv.

Then, the operator of the management terminal 11 takes a measure to improve the ability corresponding to the ability score whose evaluation is low. For example, the operator of the management terminal 11 may present the ability to be improved to the remote-control terminal 3 of the worker 4 who is an evaluation target, or may process such that the worker 4 is replaced with a worker who is relatively high in this ability. By this improvement, the evaluation value (unit work time Tv) of the work result can be accurately improved. Therefore, in the cooperative work performed by a human and a working robot, the improvement of the evaluation of the work result can be efficiently supported. The improvement of the ability may be performed only when a reference time (estimated time) of the total work time is set, and it is determined that the total work time is longer than the reference time.

The technology of the present disclosure is not limited to the above-described embodiment. For example, the cooperative work management server 10 was exemplified as the cooperative work management apparatus, but the cooperative work management apparatus is not limited to a server as long as the cooperative work management apparatus can acquire information from the remote-control terminal 3 and the working robot 2. For example, the cooperative work management apparatus may be an apparatus that controls the working robot 2. Moreover, the evaluation value is not limited to the work time and may be another item (for example, the defect rate).

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The functionality of the elements disclosed herein may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The following aspects disclose preferred embodiments.

### First Aspect

A cooperative work management apparatus that is an apparatus that manages a cooperative work system, the cooperative work system including a working robot and a remote-control terminal, the remote-control terminal being connected to the working robot through a communication network and operated by a worker,
the cooperative work management apparatus including processing circuitry configured to:
   acquire data indicating at least one of information regarding perception, determination, or instruction of the worker or information regarding operation of the working robot;
   calculate features based on the acquired data;
   calculate an evaluation value with respect to a work result of the working robot; and
   calculate contribution rates of the features with respect to the evaluation value.

According to this configuration, the feature having a high contribution rate with respect to the evaluation value (for example, the work time) of the work result of the working robot can be recognized. By improving the ability of the worker regarding this feature, the evaluation value of the work result can be accurately improved. Therefore, in the cooperative work performed by a human and a working robot, the improvement of the evaluation of the work result can be efficiently supported.

### Second Aspect

The cooperative work management apparatus according to the first aspect, wherein
the processing circuitry is further configured to:
   calculate an ability score corresponding to the feature having the highest contribution rate among the features;
   compare the ability score with a reference score; and
   output a result of the comparison between the ability score and the reference score.

According to this configuration, the ability of the worker or the working robot which is necessary to improve the feature having a high contribution rate can be easily recognized.

### Third Aspect

The cooperative work management apparatus according to the second aspect, wherein
calculating the ability score includes:
   calculating detail features obtained by dividing the feature having the highest contribution rate; and
   calculating the ability score based on the detail features.

According to this configuration, the ability of the worker or the working robot which is necessary to improve the feature having a high contribution rate can be exerted with a high degree of accuracy.

### Fourth Aspect

The cooperative work management apparatus according to any one of the first to third aspects, wherein the evaluation value includes a work time.

According to this configuration, the ability of the worker or the working robot is accurately improved, and this can contribute to the achievement of the objective regarding the work time.

### Fifth Aspect

The cooperative work management apparatus according to the fourth aspect, wherein:
the work time of the evaluation value includes at least one unit work time required for at least one unit work including elemental works; and
the features include elemental work times required for the respective elemental works.

According to this configuration, it can be recognized which one of the elemental works included in the unit work should be improved in order to achieve the objective regarding the work time.

### Sixth Aspect

The cooperative work management apparatus according to any one of the first to fifth aspects, wherein:
the evaluation value includes unit work times required for respective unit works lined up in time series, each of the unit works including elemental works;
each of the unit works includes the elemental works corresponding to each other; and
the processing circuitry is further configured to
   calculate time a series increasing/decreasing trend of elemental work times required for the respective elemental works corresponding to each other,
   calculate a continuous work ability score based on the increasing/decreasing trend,
   compare the continuous work ability score with a continuous work reference score, and
   output a result of the comparison between the continuous work ability score and the continuous work reference score.

According to this configuration, the ability of the worker or the working robot regarding the time series change in the elemental work time can be easily recognized.

### Seventh Aspect

A cooperative work management method that is a method of managing a cooperative work system including a working robot and a remote-control terminal, the remote-control terminal being connected to the working robot through a communication network and operated by a worker,
the cooperative work management method including:
acquiring data indicating at least one of information regarding perception, determination, or instruction of the worker or information regarding operation of the working robot;
calculating features based on the acquired data;
calculating an evaluation value with respect to a work result of the working robot; and
calculating contribution rates of the features with respect to the evaluation value.

According to this method, the feature having a high contribution rate with respect to the evaluation value (for example, the work time) of the work result of the working robot can be recognized. By improving the ability of the worker regarding this feature, the evaluation value of the work result can be accurately improved. Therefore, in the cooperative work performed by a human and a working robot, the improvement of the evaluation of the work result can be efficiently supported.

### Eighth Aspect

A cooperative work management program causing at least one processor to execute the cooperative work management method according to the seventh aspect.

According to this program, as with the above, in the cooperative work performed by a human and a working robot, the improvement of the evaluation of the work result can be efficiently supported.

### REFERENCE SIGNS LIST

1 cooperative work system
2 working robot
3 remote-control terminal
4 worker
5 communication network
10 cooperative work management server (cooperative work management apparatus)
60 processing circuitry
61 processor
71 principal component analysis model
E1 to E5 elemental work
Te elemental work time
Tv unit work time
V unit work

1. A cooperative work management apparatus that is an apparatus that manages a cooperative work system, the cooperative work system including a working robot and a remote-control terminal, the remote-control terminal being connected to the working robot through a communication network and operated by a worker,
the cooperative work management apparatus comprising processing circuitry configured to:
acquire data indicating at least one of information regarding perception, determination, or instruction of the worker or information regarding operation of the working robot;
calculate features based on the acquired data;
calculate an evaluation value with respect to a work result of the working robot; and
calculate contribution rates of the features with respect to the evaluation value.

2. The cooperative work management apparatus according to claim 1, wherein
the processing circuitry is further configured to:
calculate an ability score corresponding to the feature having the highest contribution rate among the features;
compare the ability score with a reference score; and
output a result of the comparison between the ability score and the reference score.

3. The cooperative work management apparatus according to claim 2, wherein
calculating the ability score includes:
calculating detail features obtained by dividing the feature having the highest contribution rate; and
calculating the ability score based on the detail features.

4. The cooperative work management apparatus according to claim 1, wherein the evaluation value includes a work time.

5. The cooperative work management apparatus according to claim 4, wherein:
the work time of the evaluation value includes at least one unit work time required for at least one unit work including elemental works; and
the features include elemental work times required for the respective elemental works.

6. The cooperative work management apparatus according to claim 1, wherein:
the evaluation value includes unit work times required for respective unit works lined up in time series, each of the unit works including elemental works;
each of the unit works includes the elemental works corresponding to each other; and
the processing circuitry is further configured to
calculate time a series increasing/decreasing trend of elemental work times required for the respective elemental works corresponding to each other,
calculate a continuous work ability score based on the increasing/decreasing trend,
compare the continuous work ability score with a continuous work reference score, and
output a result of the comparison between the continuous work ability score and the continuous work reference score.

7. A cooperative work management method that is a method of managing a cooperative work system including a working robot and a remote-control terminal, the remote-control terminal being connected to the working robot through a communication network and operated by a worker,
the cooperative work management method comprising:
acquiring data indicating at least one of information regarding perception, determination, or instruction of the worker or information regarding operation of the working robot;
calculating features based on the acquired data;
calculating an evaluation value with respect to a work result of the working robot; and
calculating contribution rates of the features with respect to the evaluation value.

8. A cooperative work management program causing at least one processor to execute the cooperative work management method according to claim 7.
